(19) United States
(12) Patent Application Publication
(10) Pub. No.: US 2006/0155457 A1
(43) Pub. Date: Jul. 13, 2006

(54) Method and system for stabilizing a vehicle combination

(75) Inventors: Dirk Waldbauer, Eppstein (DE); Jurgen Krober, Winningen (DE); Clemens Schmitt, Bensheim (DE)

Correspondence Address: Craig Hallacher;Continental Teves Inc, One Continental Drive, Auburn Hills, MI, 48326, US

(73) Assignee: Continental Teves A G & Co. oHG

(21) Appl. No.: 10/531,745

(22) PCT Filed: Nov. 7, 2003
(86) PCT No.: PCT/EP03/50803

§ 371 Date: Nov. 25, 2005

(30) Foreign Application Priority Data
Nov. 8, 2002 (DE) 102 52 508.0

(51) Int. Cl. B60T 8/24

(52) U.S. Cl. 701/72

(57) ABSTRACT

The invention relates to a method and a device for stabilizing a car-trailer combination, including a towing vehicle and a trailer moved by the towing vehicle, wherein the towing vehicle is monitored in terms of rolling motions and measures that stabilize driving are taken upon the detection of an actual or expected unstable driving performance of the towing vehicle or the car-trailer combination. In order to be able to perform, in a timely manner, an intervention on the towing vehicle that stabilizes driving, the invention provides that the measures that stabilize driving are controlled in dependence on the yaw acceleration.

### TECHNICAL FIELD

The present invention relates to a method and a device for stabilizing a car-trailer combination, including a towing vehicle and a trailer moved by the towing vehicle, wherein the towing vehicle is monitored in terms of rolling motions and measures that stabilize driving are taken upon the detection of an actual or expected unstable driving performance of the towing vehicle or the car-trailer combination.

### BACKGROUND OF THE INVENTION

The method at issue aims at detecting and controlling the instabilities of car-trailer combinations (motor vehicle with trailer), especially of combinations consisting of a passenger car and any trailers desired, in particular caravans, before driving conditions are encountered which the driver can no longer maintain control of the vehicle. These unstable conditions involve the rolling motion and the anti-phase build-up process between the towing vehicle and the trailer as well as imminent roll-over conditions at too high lateral accelerations in the event of obstacle avoidance maneuvers, lane changes, side wind, road irregularities or hasty steering maneuver requests by the driver.

Depending on the driving speed, the oscillations will decay, remain constant, or increase (undamped oscillation). When the oscillations remain constant, the car-trailer combination has reached the critical velocity. Above this speed threshold a car-trailer combination is unstable, below this threshold it is stable, meaning that is possible for the oscillations to die out.

The magnitude of this critical speed depends on the geometry data, the tire rigidities, the weight and the distribution of weight of the towing vehicle and the trailer. Further, the critical speed is lower in a braked driving maneuver than during constant travel. In turn, the critical speed is higher during accelerated driving than during constant travel.

Corresponding methods and devices are known in various designs (DE 199 53 413 A1, DE 199 13 342 A1, DE 197 42 707 A1, DE 100 34 222 A1, DE 199 64 048 A1).

DE 197 42 702 C2 discloses a device for damping rolling motions for at least one trailer towed by a towing vehicle, wherein the angular velocity of the trailer about the instantaneous center of rotation or the articulated angle about the instantaneous center of rotation is sensed and differentiated and taken into consideration for controlling the wheel brakes of the trailer. Acceleration sensors at different locations are used as sensors for the angular velocity. DE 199 64 048 A1 also provides a lateral acceleration sensor by means of which the rolling motion is determined. After the signal is evaluated, a periodic yawing torque shall be applied to the vehicle. DE 100 34 222 A1 determines a time for a braking intervention correct in phase, being realized in dependence on the quantity of frequency and the phase magnitude of the rolling motion.

Hence, the stabilization strategy of all design variants can be summarized as follows:
Detection of the rolling motion by evaluating the sensor data about the yaw rate or lateral acceleration, the steering angle and the wheel speeds, with all sensors being favorably accommodated in the towing vehicle.
When an unstable-situation is detected, the vehicle is slowed down by reducing the engine torque and building up pressure in the wheel brakes of the towing vehicle.
Additionally or alternatively a torque about the vertical axis of the towing vehicle is applied, said torque counteracting the force transmitted from the trailer to the towing vehicle and, thus, damping the oscillation.

The latter measure can be realized alternatively by way of one-sided braking interventions on at least one axle or by interventions made by an overriding steering system. In both of these methods it is necessary to apply the torque in the correct phase in order to prevent additional excitation to the oscillation.

### SUMMARY OF THE INVENTION

An object of the invention is to provide a method and a device permitting the determination of the time for the application of the counter torque that is correct in phase.

According to the invention, this object is achieved by providing a method for stabilizing a car-trailer combination because the measures that stabilize driving are controlled dependent on the yaw acceleration.

In this arrangement, an actuating signal for an electric motor of a hydraulic pump producing a brake pressure and, hence, actuating the wheel brake is generated by way of the data measured by a yaw rate sensor and derived in an ESP driving dynamics control operation and logically combined with the ESP control strategy, into which data the data of a motor vehicle can be included. It is possible alternatively or additionally to drive an actuator of an overriding steering system. By applying different brake pressures for braking a wheel of the towing vehicle or all wheels of the towing vehicle corresponding to an ESP control strategy, it is possible to correct the instabilities of the trailer detected by sensors and to reduce the possibly existing too great lateral dynamics of the car-trailer combination by reducing the lateral forces at one wheel by means of increased brake pressure and/or the increase in the longitudinal forces.

It is desirable that the yaw velocity \dot{Ψ} is determined by means of sensors and the yaw acceleration \ddot{Ψ} is derived from the yaw velocity in a model. In this arrangement, the signal \ddot{Ψ} used for quantification and control of the intervention is produced by deriving it from the signal \dot{Ψ}, which is directly provided in the driving stability control as a sensor signal of the yaw rate sensor. Thus, there is favorably no need for an additional sensor reducing the costs for the method of the invention.

The car-trailer combination is so controlled in a stabilizing manner so that the maximum of the yaw rate acceleration is determined and the measures that stabilize driving are initiated dependent on the maximum found. Subsequently, the measures that stabilize driving are advantageously maintained until the yaw acceleration reaches the value zero or a value in a tolerance band around zero. The result is that intervention takes place considerably earlier and, further, is terminated in time before the oscillation can be excited.

The additional advantage of the method involves that the intervention is always induced to become active as soon as the towing vehicle leaves its maximum excursion. The measures that stabilize driving have such an effect that the velocity of the towing vehicle swinging back to its original position is slowed down, thereby reducing the amplitude of the next oscillation.

The method favorably supplements a driving stability control, and the measures that stabilize driving are performed in parallel to an ESP control. Because the measures that stabilize driving are initiated considerably earlier when rolling is detected than an ESP intervention when a rotation about the vertical axis of the vehicle is detected, the measures that stabilize driving become effective already before an ESP control situation occurs. This can lead to avoid an ESP intervention or reduce the intensity of the ESP intervention.

According to a favorable embodiment, the measures that stabilize driving are executed during an ESP control under the condition that the ESP threshold or thresholds is/are modified, at which an ESP intervention is introduced or terminated when values exceed or fall short of said thresholds. Favorably, the ESP threshold is so modified that the ESP intervention is performed only when there is a greater difference between the nominal and the actual yaw velocity.

An ESP brake pre-intervention is performed on at least one wheel as a measure that stabilizes driving. The method allows the intervention to take place much earlier and also to be terminated in due time before the oscillation can be excited. An additional advantage of the method is that spurious interventions due to a misinterpretation of the signals do not have any negative effects on the vehicle performance. If such an intervention is activated in a vehicle without a trailer, it will always be stabilizing and become inactive instantaneously when the yaw rate decreases.

In another favorable embodiment of the method, brake pressure is maintained in the wheel brakes in the period between two consecutive ESP brake pre-interventions at the wheels, said brake pressure being rated so that the application travel of the brake remains substantially bridged. Advantageously, a small amount of brake pressure of roughly 5 bar is left to prevail to this end in the periods of time between alternating interventions at either wheel of the axle of intervention when the torque is applied by way of the wheel brakes, in order that the brake pads remain applied. This reduces the response time of the brakes, and the counter torque becomes active at a quicker rate.

Another advantage of the method involves that the calculation of the counter torque is easy to carry out because the counter torque, is determined in a correlation to the yaw acceleration according to the following relation: Counter torque=amplification*\ddot{Ψ}.

It is favorably achieved due to the dependence of the signal \ddot{Ψ} on the frequency that, based on the above-illustrated relation, higher torque requirements will automatically result in the presence of high oscillation frequencies (strong oscillations) where the operating time of the intervention becomes shorter.

Further, the object is achieved because a generic device is so configured that the device comprises an ESP driving stability control with a yaw rate sensor for sensing the yaw velocity and a determining unit, which calculates from the yaw velocity quantities representing the yaw acceleration and being provided to the ESP driving stability control for controlling the brake pressure in the wheel brakes.

An embodiment of the invention is illustrated in the accompanying drawings and described in more detail in the following.

### BRIEF DESCRIPTION OF THE DRAWINGS

In the drawings:

FIG. 1 shows a vehicle with an ESP control system;

FIG. 2 shows the signals of a swaying towing vehicle;

FIG. 3 shows a schematic exemplary view of the relation between the rotation of the vehicle about its vertical axis and the force applied to the trailer clutch.

### DETAILED DESCRIPTION OF THE PREFERRED EMBODIMENTS

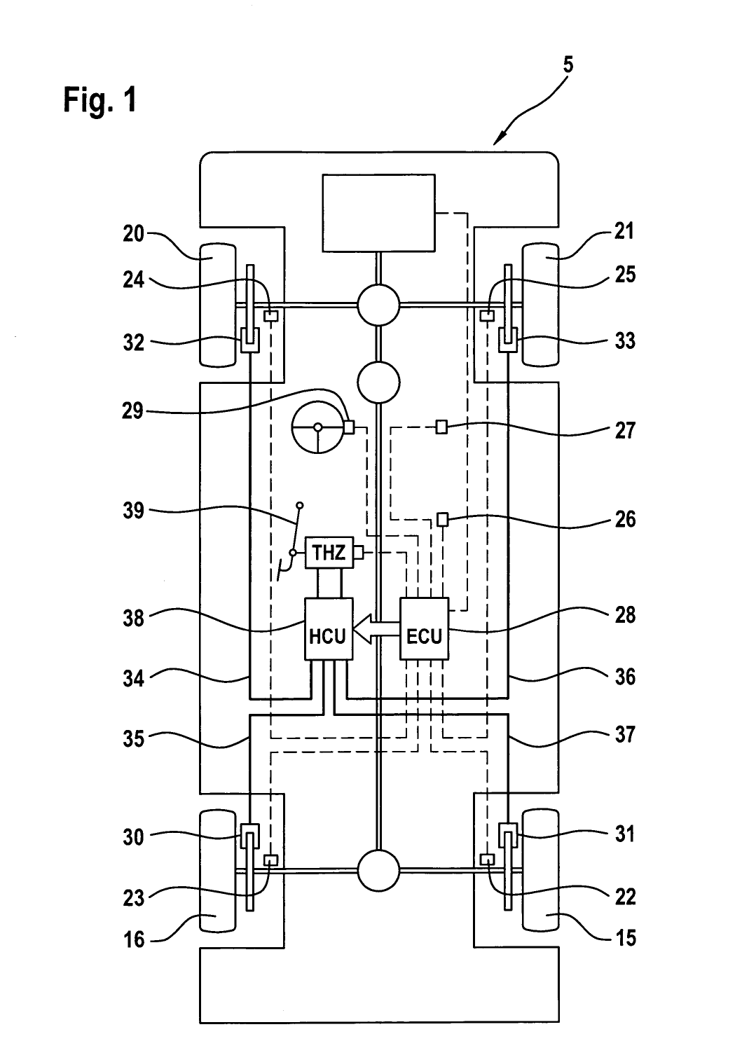

FIG. 1 shows a vehicle with an ESP control system, brake system, sensor system, and communication provisions. The four wheels have been assigned reference numerals 15, 16, 20, 21. One wheel sensor 22, 23, 24, 25 is provided at each of the wheels 15, 16, 20, 21. The signals are sent from the wheel sensors to an electronic control unit (ECU) 28 for determining from the wheel rotational speeds the vehicle speed v by way of predetermined criteria. Further, a yaw rate sensor 26, a lateral acceleration sensor 27, and a steering angle sensor 29 are connected to the ECU 28. Further, each wheel includes an individually actuatable wheel brake 30, 31, 32, 33. Each of the brakes are hydraulically operated and receive pressurized hydraulic fluid by way of hydraulic lines 34, 35, 36, 37. The brake pressure is adjusted by way of a valve block 38, said valve block being actuated irrespective of the driver by way of electric signals produced in the electronic control unit 28. The driver can introduce brake pressure into the hydraulic lines by way of a master cylinder actuated by a brake pedal. Pressure sensors P are used to sense the driver's braking request and are provided in the master cylinder or the hydraulic lines, respectively. The electronic control unit is connected to the engine control device by way of an interface (CAN).

It is possible to provide a statement about the respective driving situation and, thus, to realize an activated or deactivated control situation by way of a determination of the entry and exit conditions by means of the ESP control system with brake system, sensor system, and communication provisions that includes the following pieces of equipment:
Four wheel speed sensors
Pressure sensor (brake pressure in the master cylinder pₘₐᵢₙ)
Lateral acceleration sensor (lateral acceleration signal a_{actual}, lateral inclination angle α)
Yaw rate sensor (\dot{Ψ})
Steering wheel angle sensor (steering angle δ, steering angle velocity \dot{δ})
Individually controllable wheel brakes
Hydraulic unit (HCU)
Electronic control unit (ECU).

This renders possible one main component of the method for stabilizing car-trailer combinations, i.e. the detection of driving situations, while the other main component, i.e. the interaction with the brake system, also makes use of the essential components of the driving stability control.

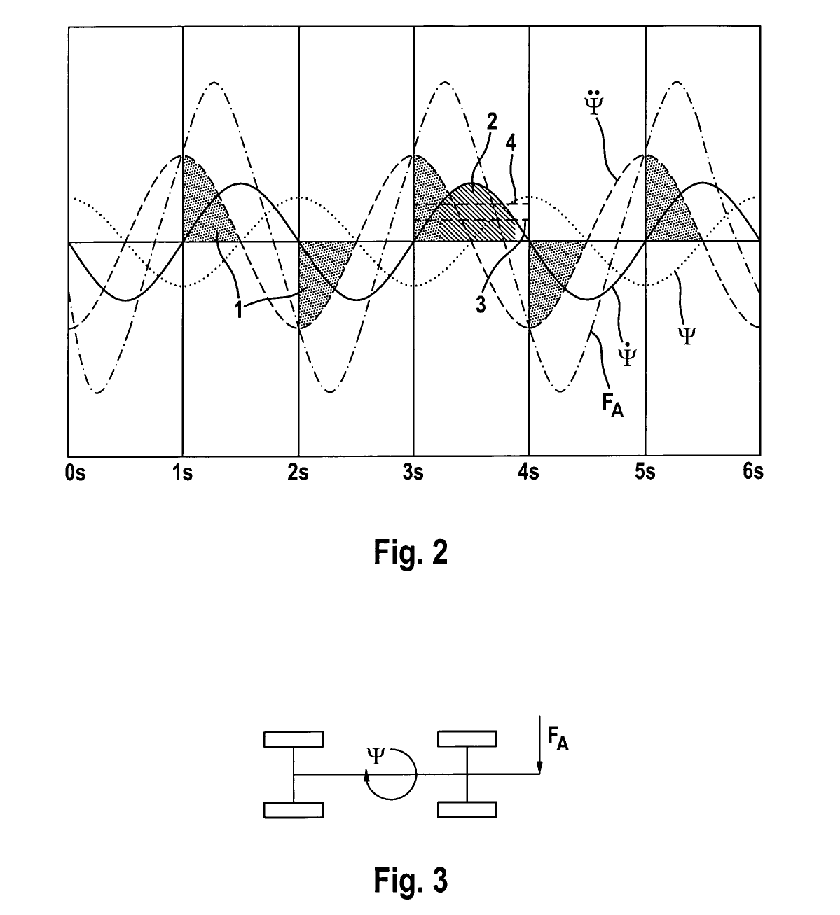

FIG. 2 illustrates the signals of a swaying towing vehicle.

The major signals are illustrated and designated as follows:
Ψ yaw angle of the towing vehicle (dotted line)
\dot{Ψ} yaw rate of the towing vehicle (solid line)
\ddot{Ψ} yaw acceleration of the towing vehicle (dot-dash line)
F_{A} force which the trailer applies to the trailer coupling in the y-direction (dash-and-dot line).

A conventional ESP intervention is used to produce an additional torque by purposeful interventions at the individual brakes of a vehicle, said torque adapting the actually measured yaw angle variation per unit of time (actual yaw rate \dot{Ψ}_{actual}) of a vehicle to the yaw angle variation per unit of time (nominal yaw rate \dot{Ψ}ₙₒₘᵢₙₐₗ) influenced by the driver. In this arrangement, input quantities which result from the track desired by the driver (e.g. steering wheel angle, driving speed) are always sent to a vehicle model circuit which, by way of a prior-art single track model or any other driving model, determines a nominal yaw rate (\dot{Ψ}nominal) from these input quantities and from parameters being characteristic of the driving performance of the vehicle, but also from quantities (coefficient of friction of the roadway), which nominal yaw rate is compared to the measured actual yaw rate (\dot{Ψ}_{actual}). The difference between the nominal and the actual yaw rate (Δ\dot{Ψ}_{Diff}) is converted by means of a so-called yaw torque controller into an additional yaw torque M_{G} which represents the input quantity of a distribution logic.

Said distribution logic, in turn, determines the brake pressure to be applied to the individual brakes, possibly in dependence on a braking request of the driver demanding a defined brake pressure at the wheel brakes. The purpose of the brake pressure is to produce an additional torque at the vehicle in addition to the maybe desired brake effect, said torque supporting the driving performance of the vehicle in the direction of the steering request of the driver.

The ESP driving stability control becomes active a soon as the yaw rate Δ\dot{Ψ}_{Diff} exceeds a top threshold 4. The extent of the intervention is calculated by way of the magnitude of the yaw rate difference. When the yaw rate \dot{Ψ}_{actual} falls under a bottom threshold 3, the intervention is terminated. The thresholds 3, 4 (broken horizontal lines) and the period of time of the intervention (2, hatched area) are shown in FIG. 2.

In order to dampen oscillations of a car-trailer combination, the applied yaw torque M_{G} must counteract the force F_{A} acting on the trailer coupling. This is not the case in the conventional ESP intervention. On the one hand, the ESP intervention acts only late, on the other hand, for too long a period under certain circumstances, so that the torque will even augment the swing movement of the trailer.

Therefore, the method forms in a model the derivative of the yaw velocity \ddot{Ψ} in order to control the intervention. Thus, the ESP brake pre-intervention takes place much earlier and, in addition, is terminated in due time before the oscillation can be excited. The period of time during which the brake pre-intervention is active is illustrated in FIG. 2 (1, solidly filled). It is advantageous with said method that the intervention will always become active as soon as the towing vehicle 5 represented in FIG. 3 moves out of the maximum excursion. As this occurs, the backswing speed of the towing vehicle 5 is slowed down and, thus, the amplitude of the next oscillation reduced. Another advantage of the method is that possible spurious interventions due to misinterpretation of the signals will not have any negative effects on the vehicle performance. If such a brake pre-intervention is activated in a vehicle without trailer, it will always act in a stabilizing manner and become instantaneously inactive when the yaw rate decreases.

In another favorable embodiment of the method, a small amount of brake pressure (roughly 5 bar) is left to prevail in the periods of time between alternating interventions at either wheel of the axle of intervention when the torque is applied by way of the wheel brakes, in order that the brake pads remain applied. This reduces the response time of the brakes, and the counter torque becomes active at a quicker rate.

Another advantage of the method involves that the calculation of the counter torque is easy to carry out: Counter torque=amplification*\ddot{Ψ}.

Still another advantage of the method is that due to the dependence of the signal \ddot{Ψ} on the frequency as based on the above-illustrated formula of calculation, higher torque requirements will automatically result in the presence of high oscillation frequencies (strong oscillations) where the operating time of the intervention becomes shorter.

The method of the invention is not limited to the embodiment described hereinabove and also includes the possibility of producing a signal optionally shifted in phase to the yaw rate or lateral acceleration corresponding to the yaw angle acceleration, which signal is also representative of the lateral dynamics, in order to control the stabilizing brake torque.

1-11. (canceled)

12. A method for stabilizing a car-trailer combination, including a towing vehicle and a trailer moved by the trailing vehicle, the method comprising:
monitoring rolling motions of a towing vehicle, wherein the monitored rolling motions include yaw acceleration; and
performing one or more measures that stabilize driving of the towing vehicle, wherein the measures that stabilize driving of the towing vehicle are controlled based on the yaw acceleration.

13. The method according to claim 12 further comprising:
determining yaw velocity of the towing vehicle utilizing one or more sensors; and
deriving yaw acceleration by using a model.

14. The method according to claim 12 further comprising:
determining a maximum yaw acceleration, wherein the measures that stabilize driving of the towing vehicle are initiated based on the determined maximum yaw acceleration.

15. The method according to claim 12, wherein the measures that stabilize driving of the towing vehicle are maintained until the yaw acceleration reaches a zero value or a value in a tolerance band around zero.

16. The method according to claim 12, wherein the measures that stabilize driving of the towing vehicle are performed in parallel to an Electronic Stability Program (ESP) control.

17. The method according to claim 16, wherein the measures that stabilize driving of the towing vehicle are executed during an ESP control under a condition that the ESP threshold or thresholds are modified at which an ESP intervention is introduced or terminated when values exceed or fall short of the threshold or thresholds.

18. The method according to claim 17, wherein at least one ESP threshold is modified so that the ESP intervention is performed only when there is a greater difference between a nominal yaw velocity and an actual yaw velocity.

19. The method according to claim 16, wherein one of the measures that stabilize driving of the towing vehicle includes performing an ESP brake pre-intervention on at least one wheel.

20. The method according to claim 19, wherein brake pressure in one or more wheel brake is maintained in a period between two consecutive ESP brake pre-interventions and said brake pressure is rated so that the application travel of the brake remains substantially bridged.

21. The method according to claim 19 further comprising:
calculating a counter torque for the ESP brake pre-intervention to achieve in correlation to the yaw acceleration according to the relation Counter torque=amplification*\ddot{Ψ}.

22. A device for stabilizing a car-trailer combination, including a towing vehicle and a trailer moved by the towing vehicle, the device comprising:
a monitoring device for monitoring rolling motions of a towing-vehicle;
a detector for detecting an actual or expected unstable driving performance of the towing vehicle; and
a controller for controlling one or measures that stabilize driving of the towing vehicle or the car-trailer combination, wherein the controller controls the one or more measures that stabilize driving of the towing vehicle based on the rolling motions.

23. The device of claim 22 further comprising:
an Electronic Stability Program (ESP) control having a yaw rate sensor for sensing yaw velocity and a determining unit that calculates quantities representing the yaw acceleration based on the sensed yaw velocity, wherein the ESP control controls the brake pressure in at least one wheel brake based upon the calculated quantities.
